(19) United States
(12) Patent Application Publication
(10) Pub. No.: US 2003/0203712 A1
(43) Pub. Date: Oct. 30, 2003

(54) Car wash air curtain

(76) Inventor: James S. Nucci, Fort Wayne, IN (US)

Correspondence Address: BAKER & DANIELS, 111 E. WAYNE STREET, SUITE 800, FORT WAYNE, IN, 46802

(21) Appl. No.: 10/422,024

(22) Filed: Apr. 23, 2003

Related U.S. Application Data
(60) Provisional application No. 60/375,186, filed on Apr. 24, 2002.

(51) Int. Cl. B01L 1/04

(52) U.S. Cl. 454/187

(57) ABSTRACT

A air curtain adapted for use in a car wash. The air curtain includes a rotating diffuser allowing for multiple airflow trajectories, including airflow trajectories having vector components both into and out of the car wash tunnel. The air curtain utilizes a variable cross-section duct connected to the rotating diffuser to provide a constant velocity airflow from the numerous air outlets in the rotating diffuser with only a single motor and blower acting as a source of airflow.

### BACKGROUND OF THE INVENTION

1. Field of the Invention

The present invention relates to an air curtain for preventing ambient air from entering an enclosure through a door thereof, and, more particularly, to an air curtain particularly adapted for use in a car wash.

2. Description of the Related Art

Air curtains can be utilized to provide airflow across a doorway or other opening, to, e.g., reduce airflow in or out of an enclosed space accessed by the doorway, and prevent insects from entering the enclosed space. Reducing airflow out of the enclosed space works to retain conditioned air therein. To achieve the aforementioned goals, known air curtains are adapted to provide an airflow having a vector component perpendicular to the frame of the relevant doorway and directed out of the doorway. A number of air ducts or nozzles are progressively positioned along the width of the doorway to provide the desired airflow. Each duct or nozzle is secured to the door frame in an orientation providing the desired airflow trajectory, i.e., a trajectory having a vector component perpendicular to the frame of the relevant doorway and directed out of the doorway. To provide a constant velocity airflow across the width of a door, each duct has an associated motor and blower for accelerating air through the duct. Each motor/blower combination is positioned directly above the associated duct.

Many car washes are arranged as tunnels, with cars entering an entrance to the tunnel, being directed through the tunnel on a conveyor track, and thereafter exiting the tunnel. The car wash tunnel includes progressively positioned pre-soak, wash, and rinse stations for washing the car as it is guided through the tunnel. In cold climates, car washes typically include devices designed to prevent ambient air from entering the car wash tunnel to facilitate heat retention and prevent freezing of car wash components including, e.g., soft cloths and sprayer nozzles. Typically, the entrance and exit of the car wash is equipped with a door which is opened to allow a car to enter or exit the car wash and is thereafter closed. Conventional “garage doors” can be utilized, or doors formed from a number of plastic panels hung in a vertical orientation on a track. Garage doors associated with car washes are opened and closed in a conventional manner, and plastic panel doors are opened and closed by moving the panels in a horizontal direction. Doors positioned at the entrance and exit of a car wash cannot entirely prevent ambient air from entering the car wash because the doors must be opened to allow a car to enter or exit the car wash.

Due to the orientation of the entrance and exit of a car wash tunnel, i.e., at opposite ends of the tunnel, a conventional air curtain cannot easily be utilized to prevent ambient air from entering the car wash because the nozzles or ducts of conventional air curtains have a fixed position with respect to the door frame. For example, if the car wash tunnel has an east/west orientation, with the entrance positioned east of the exit, then ambient airflow traveling west to east, i.e., a westerly wind will not be retarded by a conventional air curtain positioned at the entrance of the car wash. To the contrary, such a westerly wind will be facilitated by a conventional air curtain positioned at the entrance of the example car wash. Moreover, the multiple motor/blower combinations of a conventional air curtain cannot be positioned at the entrance or exit of a car wash because of the size of this structure and the relatively small overhead space provided in a car wash.

What is needed in the art is an air curtain adapted for use in a car wash to prevent ambient air from entering the car wash.

What is further needed in the art is an air curtain designed to provide consistent velocity airflow from a number of air outlets utilizing a single motor and blower to accelerate the air.

### SUMMARY OF THE INVENTION

The present invention provides an air curtain adapted for use in a car wash. The air curtain of the present invention includes a rotating diffuser allowing for multiple airflow trajectories, including airflow trajectories having vector components both into and out of the car wash tunnel. Moreover, the air curtain of the present invention utilizes a variable cross section duct connected to the rotating diffuser to provide a consistent velocity airflow from the numerous air outlets in the rotating diffuser with only a single motor and blower acting as a source of airflow.

With the car wash environment in mind, the air curtain of the present invention is, in one embodiment thereof, constructed from a non-corrosive material such as aluminum or stainless steel. The rotating diffuser and variable cross section duct of the air curtain of the present invention are generally positioned along the top of the relevant door frame. Various additional parts of the air curtain are located below and offset from the variable cross section duct and rotating diffuser, including an air inlet, a conditioning section (e.g., heating coils), and a blower (including the associated motor) with various transition sections located therebetween. Generally the air inlet, conditioning section, and blower are vertically oriented, i.e., the airflow through the air curtain is generally vertical as it traverses these sections of the air curtain. With this in mind, an elbow is utilized to connect the aforementioned portions of the air curtain of the present invention to the variable cross section duct and rotating diffuser, with the airflow being generally horizontal through the variable cross section duct until being directed out from the rotating diffuser with a vertical component of direction, and, typically, a horizontal component of direction as well.

A handle is operably connected to the rotating diffuser to allow for manual adjustment thereof into multiple positions, including positions in which the airflow from the rotating diffuser has a directional component into the car wash tunnel, or out of the car wash tunnel. In all cases, the airflow from the rotating diffuser has a vertical component. The rotating diffuser may also be repositioned by a motor. In embodiments in which the rotating diffuser is motorized, a control unit will be connected to the rotating diffuser motor to control energization of the motor to reposition the diffuser. The present invention further contemplates the provision of a wind detector, e.g., a weather vane communicatively connected to the control unit to automatically control the control unit and, therefore, the position of the rotating diffuser. Additionally, the heating coils may be provided with temperature controls allowing for variable fluid temperature

In one embodiment of the present invention, rotating diffusers are associated with both the entrance and the exit of the car wash. The two diffusers of this embodiment of the present invention may be adjusted to account for ambient airflows tending to enter the car wash from either the entrance or the exit. If an ambient airflow is tending to enter the car wash through the entrance to the car wash, the rotating diffusers may be positioned so that the airflow exiting the entrance diffuser exits the car wash, while the airflow exiting the exit diffuser enters the car wash. Stated another way, the rotating diffusers of this embodiment of the present invention can be adjusted, so that the air exiting each diffuser has a directional component into the wind, whether the wind is tending to enter the entrance to the car wash or is tending to enter the exit of the car wash.

As described above, the duct supplying air to the rotating diffuser comprises a variable cross section duct. Specifically, the cross section of a diffuser in accordance with the present invention varies along its length, with the cross sectional area adjacent the elbow connecting the duct to the blower comprising the largest cross section of the duct, and the cross section of the end of the duct furthest from the elbow being the smallest, with the cross section of the duct progressively decreasing in size from the largest to the smallest cross section. The variable cross section duct of the present invention provides a consistent air pressure across the entire length of the duct to allow the numerous ducts of the rotating diffuser to provide a consistent velocity airflow across the entire length of the rotating diffuser, with only a single source of air being utilized.

The invention, in one form thereof, comprises a method of preventing ambient air from entering a building through at least one of a pair of doors allowing access to the building. The method of this form of the present invention includes the steps of: providing a first air curtain positioned adjacent a first one of the pair of doors, the first air curtain having a first rotatable diffuser through which a first air curtain airflow can pass, the first rotatable diffuser rotatable relative to the building; and rotating the first air curtain diffuser to a position wherein the first air curtain airflow is directed out of the building through one of the pair of doors.

The invention, in another form thereof, comprises a building and an air curtain combination. The combination of this form of the present invention includes a building having a pair of doors allowing access to the building and an air curtain including: an intake duct; a blower in fluid communication with the air intake duct, the blower operable to provide an airflow into the air intake duct and through the blower; a distribution duct in fluid communication with the blower, the distribution duct receiving the airflow from the blower; and a rotatable diffuser rotatably connected to the building, the rotatable diffuser having a plurality of air outlets, the rotatable diffuser in fluid communication with the distribution duct, whereby the airflow exits the air curtain through the air outlets, the rotatable diffuser rotatable between a first position in which the airflow is directed through the air outlets and out of a first of the pair of doors and a second position in which the airflow is directed through the air outlets and out a second of the pair of doors.

The invention, in another form thereof, comprises an air curtain including an air intake duct; a blower in fluid communication with the air intake duct, the blower operable to provide an airflow into the air intake duct and through the blower; a variable cross-section distribution duct in fluid communication with the blower, the variable cross-section distribution duct receiving the airflow from the blower, the variable cross-section duct having a variable cross-section along its length, whereby the airflow creates a substantially constant air pressure in the variable cross-section duct; and a diffuser having a plurality of air outlets, the diffuser in fluid communication with the distribution duct, whereby the airflow exits the air curtain through the air outlets.

The invention, in yet another form thereof, comprises an air curtain including an air intake duct; a blower in fluid communication with the air intake duct, the blower operable to provide an airflow into the air intake duct and through the blower; a distribution duct in fluid communication with the blower, the distribution duct receiving the airflow, the distribution duct including air pressure means for creating a substantially constant air pressure in the air distribution duct; and a diffuser having a plurality of air outlets, the diffuser in fluid communication with the distribution duct, whereby the airflow exits the air curtain through the air outlets.

The variable cross section duct of the present invention advantageously permits a single motor and blower to provide a consistent air pressure across the entire length of the variable cross section duct whereby the numerous nozzles or ducts of the rotating diffuser provide a consistent airflow velocity.

The rotating diffuser of the present invention advantageously allows a pair of air curtains in accordance with the present invention positioned at the entrance and exit of, e.g., a car wash tunnel to be positioned whereby the airflow from both diffusers has a directional component into the wind.

The variable cross section duct of the present invention advantageously allows the air curtain of the present invention to be powered by a single blower/motor combination.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a top, sectional view illustrating a car wash tunnel equipped with a pair of air curtains in accordance with the present invention;

FIG. 2 is a front plan view illustrating an air curtain of the present invention;

FIG. 3 is a partial plan view of an air curtain of the present invention taken along line 3-3 of FIG. 2;

FIG. 4 is a sectional view of the air curtain illustrated in FIG. 2 taken along line 4-4 of FIG. 2 and illustrating a handle operable to manually actuate the rotating diffuser of the present invention; and

FIG. 5 is a sectional view illustrating a variable cross section duct and rotating diffuser combination in accordance with the present invention.

Corresponding reference characters indicate corresponding parts throughout the several views. Although the drawings represent embodiments of the present invention, the drawings are not necessarily to scale and certain features may be exaggerated to better illustrate and explain the present invention. The exemplifications set out herein illustrate embodiments of the invention, and such exemplifications are not to be construed as limiting the scope of the invention in any manner.

### DETAILED DESCRIPTION OF THE INVENTION

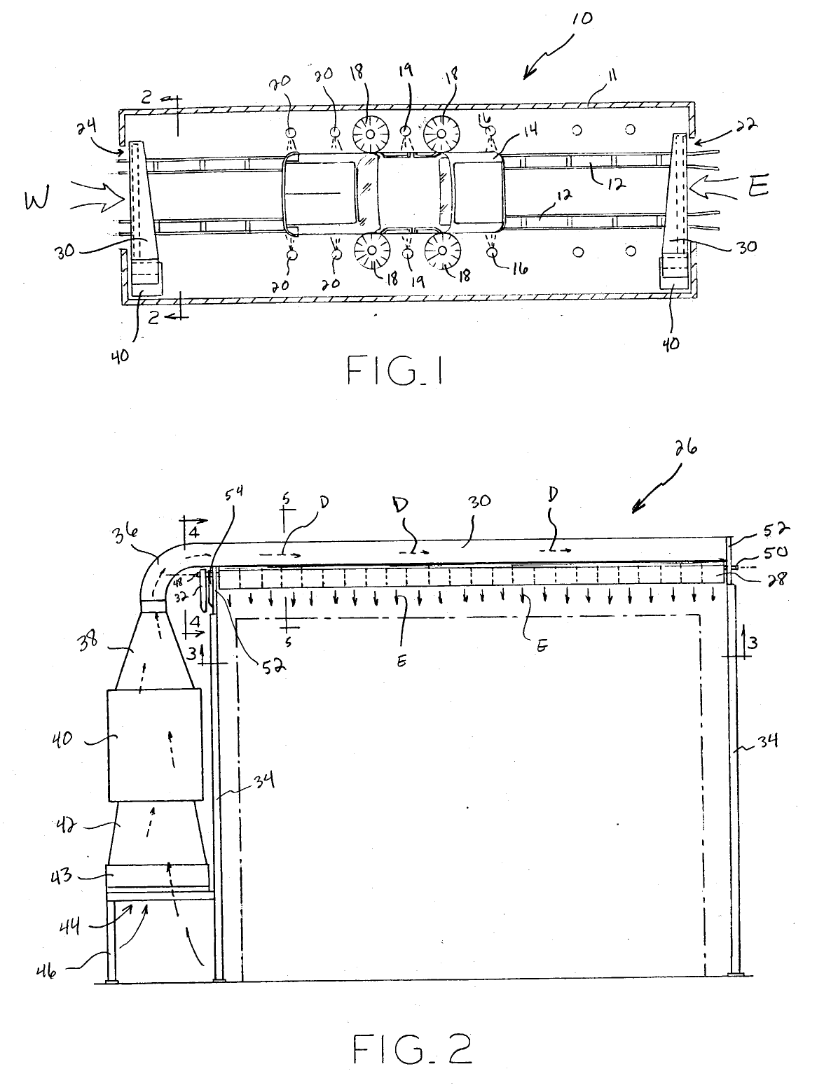

As illustrated in FIG. 2, air curtain 26 includes air inlet 44 supported by leg 46 and upright 34. Air inlet 44 allows for airflow into air curtain 26 and, in one embodiment of the present invention includes an air filter positioned to prevent debris from entering air curtain 26. Air inlet 44 is connected via hot water coil 43, and transition 42 to blower 40. Blower 40 is connected to a motor and creates an airflow into air inlet 44. Air is drawn by blower 40 into air inlet 44, past hot water coil 43, and through transition 42. Blower 40 thereafter pushes air into transition 38, elbow 36, and variable cross section duct 30. As described above, the cross section of variable cross section duct 30 varies along its length to provide constant air pressure therein. Variable cross section duct 30 is in fluid communication with rotating diffuser 28 and provides consistent velocity airflow through a number of air outlets in rotating diffuser 28.

FIG. 1 illustrates car wash 10 equipped with a pair of air curtains in accordance with the present invention. As illustrated in FIG. 1, car wash 10 includes car wash tunnel 11 having entrance 22 and exit 24 as well as conveyor track 12. In use, a vehicle enters car wash tunnel 11 through entrance 22 and is pulled or pushed through car wash tunnel 11 by conveyor track 12. FIG. 1 schematically depicts a typical car wash tunnel including presoak nozzles 16, scrubbers 18, soap nozzles 19, and rinse nozzles 20. As illustrated, car 14 is moved through car wash tunnel 11 on conveyor track 12 and progressively passes presoak, wash, and rinse stations in the car wash. As illustrated in FIG. 1, an air curtain of the present invention is positioned at entrance 22 as well as exit 24. Each of these air curtains is designed to provide a constant velocity airflow across the width of the associated doorway. Moreover, as will be further described hereinbelow, each air curtain is operable to provide an airflow having a vector component generally parallel to conveyor track 12 and directed either into car wash tunnel 11 or out from one of entrance 22 and exit 24.

Car wash 10 illustrated in FIG. 1 is shown as having an east-west configuration, with exit 24 located on a west end of car wash 10 and entrance 22 located on an east end of car wash 10. In the case of a westerly wind W as illustrated in FIG. 1, both the entrance and the exit air curtains will be adjusted to provide an airflow having a vector component into the wind, i.e., directed toward exit 24. In the case of an easterly wind E as schematically depicted in FIG. 1, both air curtains will be configured to provide airflow having a vector component into the wind, i.e., toward entrance 22.

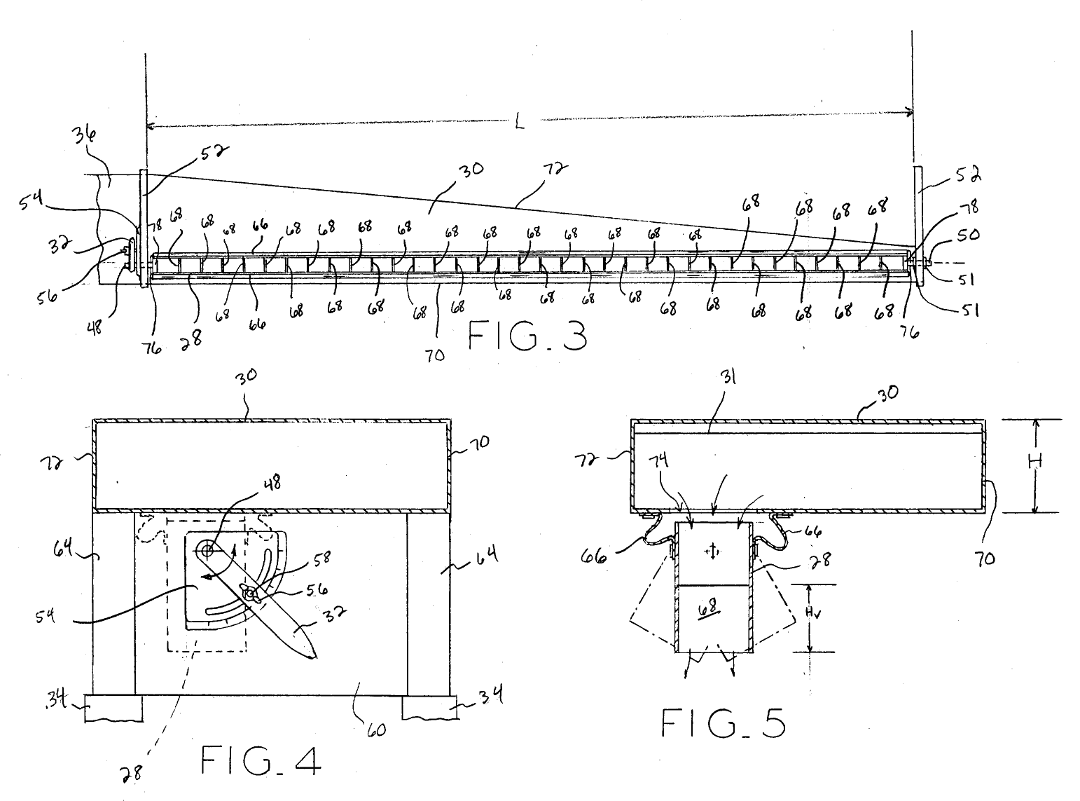

FIG. 3 illustrates rotating diffuser 28 and variable cross section duct 30 of an air curtain of the present invention. Variable cross section duct 30 and rotating diffuser 28 are further depicted, e.g., in FIG. 5. As illustrated in FIG. 5, variable cross section duct 30 has height H. Height H is consistent across the length of variable cross section duct 30 as depicted in FIG. 2. The cross section of variable cross section duct 30 is varied, e.g., by varying the distance between front wall 70 and rear wall 72 of variable cross section duct 30. Furthermore, internal baffle 31 (FIG. 5) is utilized to vary the internal height of variable cross section duct 30. Internal baffle 31 is arc shaped with the distance of internal baffle 31 to the bottom of variable cross section duct 30 being substantially equal to H at the end of variable cross section duct 30 adjacent elbow 36 and being zero at the distal end of variable cross section duct 30. Internal baffle 31 is arc shaped as opposed to linear to provide optimum ratios of h/w along the length of variable cross section duct 30 to decrease frictional losses through variable cross section duct 30, with h and w denoting the height and width of a cross section of variable cross section duct 30. In alternative embodiments of the present invention, the height of variable cross section duct 30 will vary along the length. For example, the height of variable cross section duct 30 may be varied to lessen friction losses through the length of the duct.

FIG. 3 illustrates an embodiment of the present invention in which rear wall 72 tapers from a point adjacent elbow 36, i.e., an air inlet for variable cross section duct 30 to the distal end of variable cross section duct 30, i.e., the end of variable cross section duct 30 furthest from elbow 36. FIG. 3 illustrates an arrangement in which rear wall 72 tapers linearly. This depiction is schematic in nature, and rear wall 72 may, in practice, taper along an arc.

As illustrated in FIG. 5, rotating diffuser 28 is operatively associated with variable cross section duct 30 so that airflow exits variable cross section duct 30 at air outlet 74 and travels through rotating diffuser 28. As illustrated in FIG. 5, lateral diaphragms 66 are positioned between rotating diffuser 28 and variable cross section duct 30 and provide a seal therebetween. Referring to FIG. 3, end diaphragms 76 are provided on either end of rotating diffuser 28 to complete sealing between rotating diffuser 28 and variable cross section duct 30. Lateral diaphragms 66 and end diaphragms 76 are constructed of a flexible, heat resistant, and air impermeable material. The flexibility of lateral diaphragms 66 and end diaphragms 76 allow for relative rotation of rotating diffuser 28 relative to variable cross section duct 30, while maintaining a seal therebetween. In one exemplary embodiment, lateral diaphragm 66 and end diaphragm 76 are formed of DUROLON available from Duro Dyne Corp. The DUROLON material is woven fiberglass coated with hypalon.

Referring to FIGS. 3 and 4, rotating diffuser 28 is pivotally connected to support plates 52 positioned on either end thereof via pivot pins 48, 50. Support plates 52 are rigidly secured to variable cross section duct 30 or are otherwise stationary with respect to variable cross section duct 30. Pivot pins 48, 50 are rigidly secured to end walls 78 of rotating diffuser 28, and traverse appertures in support plates 52 to provide for rotation of rotating diffuser 28 relative to support plates 52. Proximal pivot pin 48 is further rigidly connected to handle 32. In this way, handle 32 can be manipulated to rotate rotating diffuser 28 relative to variable cross section duct 30 into alternate positions as illustrated, e.g., in FIG. 5. Various mechanisms, including, e.g., washers 51 may be utilized to control the resistance to rotation of rotating diffuser 28. As illustrated in FIG. 4, handle 32 is connected to handle locking plate 54 via bolt 58 and wing nut 56. Once rotating diffuser 28 is positioned as desired, wing nut 56 may be tightened to secure handle 32 to handle locking plate 54 and retain the position of rotating diffuser 28.

In alternative embodiments, pivot pins 48, 50 can be connected to one or more motors whereby energization of these motor(s) will actuate rotating diffuser 28. In one alternative embodiment, a motor connected to one of pivot pins 48, 50 is further connected to a controller for controlling energization of the motor. In this embodiment, the controller is further connected to a wind sensor designed to detect wind direction, e.g., a weather vane. The controller receives data related to wind direction and, based thereon, automatically repositions rotating diffuser 28 as necessary to prevent ambient winds from entering car wash 10. Both the entrance and the exit air curtains can be motorized as described above.

As illustrated in FIG. 3, a plurality of vanes 68 are positioned along the length of rotating diffuser 28 to redirect duct airflow D into diffuser airflow E as schematically depicted in FIG. 2. This redirection requires a 90 degree turning of the air stream. With this in mind, vanes 68 are positioned perpendicular to duct airflow D. Each vane extends across the entire width of the outlet and, in one exemplary embodiment of the present invention, the ratio of the height of the vane, i.e., the distance the vane extends into the diffuser (Hv in FIG. 5) to the distance between the next adjacent vane equals 1.5.

It is contemplated that copper tubing can be used for hot water coil 43 and a corrosion resistant material such as aluminum or stainless steel can be used to construct the duct work, framing and rotating diffuser of the present invention. Moreover, hot water coil 43 can be connected to controls for regulating the fluid temperature therein to advantageously provide operating efficiency and cost savings to the user. Hot water coil 43 provides the further advantage of heating the car wash. For example, if the entrance and exit air curtains are positioned to provide an airflow to combat a westerly wind W in the example depicted in FIG. 1, then the warmed air from the entrance air curtain will be directed into car wash 10 and heat the same. Generally, a car wash is only heated to a temperature above freezing to avoid freezing of, e.g., the scrubbers and nozzles. With this in mind, the aforementioned temperature control can be used to lower the temperature of air exiting air curtains 26 when ambient temperatures are not excessively cold.

### EXAMPLE

In one exemplary installation, an air curtain of the present invention was designed to provide a 6,000 cubic feet per minute (CFM) airflow using a 5 horsepower motor. In this embodiment, the air curtain utilizes hot water coils providing 230,00 BTU using a water temperature of 200° F. and a flow rate of 20 fluid gallons per minute. The hot water coil of this embodiment was constructed using an aluminum fin and copper tubing. With a 6,000 CFM airflow entering the variable cross section duct, the following equations were utilized to determine the cross sectional areas of the variable cross section duct along its length.

v=Q/A [1]

A=wh [2]

Q_{L}=(Q_{I}/L_{T})L [3]

W_{L}=0.1L+10 [4]

h_{L}=(1.836L)/(0.1L+10) [5]

where

v airflow velocity in the variable cross section duct

Q=volumetric airflow

A=cross sectional area of the variable cross section duct

w=width of a cross sectional area of the variable cross section duct

h=height of a cross sectional area of the variable cross section duct

Q_{L} volumetric airflow as a function of L (defined below)

Q_{I}=initial volumetric airflow into the variable cross section duct

L_{T} the total length of the variable cross section duct

L=the location of a particular cross section measured from the distal end of the variable cross section duct

A_{L} the area of a cross section of the variable cross section duct as a function of L

w_{L}=the width of a cross section of the variable cross section duct as a function of L

h_{L}=the width of a cross section of the variable cross section duct as a function of L

This exemplary air curtain includes a variable cross section duct having a ten foot length (“L” in FIG. 3), a cross section adjacent the elbow measuring 10″×22″, and a distal cross section having a width of 10″. Initially, equations 1 and 2 above were utilized to determine the velocity of airflow at the cross section adjacent the elbow as indicated below.

v=Q/A

A=wh

v=Q/wh

v=6,000 CFM/22 in×10 in=3,922 ft/min=47,064 in/min

Next, calculations were made to determine the cross sections required along the 10 foot long variable cross section duct to maintain an airflow velocity (v) of 3,922 ft/min along the length of the duct. To make this determination, the initial determination was made that volumetric airflow will constantly decrease along the length of the variable cross section duct. Based on this determination, equation 3 above was derived. To determine a value of w as a function of L, the slope of the back wall of the diffuser was determined (note that the back wall of the diffuser will converge from the end adjacent the elbow to the distal end thereof, with the front wall position being constant) and an equation for the line of the back wall was determined (i.e., equation 4 above), taking the front wall as the positive x-axis, the intersection of the front wall and the distal end of the variable cross section duct as the origin, with the distal end wall being the positive y-axis. Finally, equation 3 was utilized to determine h as a function of L (i.e., equation 5 above) as follows.

Q=(6,000 CFM/120″)L=(50 ft³/min·in)L=86,400 in³/min·in

Q=vA, therefore,

A=Q/v=(86,400 in³/min·in)/(47,064 in/min)=(1.836 in)L

A_{L}=W_{L}h_{L}, therefore,

h_{L}=A_{L}/W_{L}=[(1.836 in)L]/(0.1L+10)

Utilizing equations 4 and 5 above, the height and width of cross sections along the length were determined. The width was altered along the length of the variable cross section duct according to equation 4, with the back wall of the variable cross section duct converging from the proximal end to the distal end of the variable cross section duct to adjust the width as necessary. The height of the variable cross section duct was varied by supplying an internal baffle generally parallel to the bottom wall of the variable cross section duct at any cross section thereof and spanning the length of the variable cross section duct. The baffle travels along an arc from the proximal end of the variable cross section duct to the distal end thereof. While the height of the baffle will go to zero at the distal end of the variable cross section duct according to equation 5 above, a minimal height, e.g., 0.5″ is maintained.

While this invention has been described as having a preferred design, the present invention can be further modified within the spirit and scope of this disclosure. This application is therefore intended to cover any variations, uses, or adaptations of the invention using its general principles. Further, this application is intended to cover such departures from their present disclosure as come within known or customary practice in the art to which this invention pertains and which fall within the limits of the appended claims.

What is claimed is:

1. A method of preventing ambient air from entering a building through at least one of a pair of doors allowing access to the building, the method comprising the steps of:
providing a first air curtain positioned adjacent a first one of said pair of doors, said first air curtain having a first rotatable diffuser through which a first air curtain airflow can pass, said first rotatable diffuser rotatable relative to the building; and
rotating said first air curtain diffuser to a position wherein said first air curtain airflow is directed out of the building through one of the pair of doors.

2. The method of claim 1, further comprising the steps of:
detecting a horizontal directional component of the ambient air and repeating said rotating step as necessary to position said first rotatable diffuser to a position wherein said first air curtain airflow has a horizontal directional component opposite the detected horizontal directional component of the ambient air.

3. The method of claim 1, further comprising the steps of:
providing a second air curtain positioned adjacent a second one of said doors, said second air curtain having a second rotatable diffuser through which a second air curtain airflow can pass, said second rotatable diffuser rotatably relative to the building; and
rotating said second air curtain diffuser to a position wherein said second air curtain airflow is directed out of the building through one of the pair of doors.

4. The method of claim 3, further comprising the steps of:
detecting a horizontal directional component of the ambient air and repeating said rotating steps as necessary to position said first rotatable diffuser and said second rotatable diffuser to positions wherein said first air curtain airflow and said second air curtain airflow has a horizontal directional component opposite the detected horizontal directional component of the ambient air.

5. A building and an air curtain combination, comprising:
a building having a pair of doors allowing access to said building; and
an air curtain, comprising:
an air intake duct;
a blower in fluid communication with said air intake duct, said blower operable to provide an airflow into said air intake duct and through said blower;
a distribution duct in fluid communication with said blower, said distribution duct receiving said airflow; and
a rotatable diffuser rotatably connected to said building, said rotatable diffuser having a plurality of air outlets, said rotatable diffuser in fluid communication with said distribution duct, whereby said airflow exits the air curtain through said air outlets, said rotatable diffuser rotatable between a first position in which said airflow is directed through said air outlets and out of a first of said pair of doors, and a second position in which said airflow is directed through said air outlets and out of a second of said pair of doors.

6. The combination of claim 5, wherein said rotatable diffuser is positioned adjacent said first of said pair of doors and spans a width of said first of said pair of doors.

7. The combination of claim 5, further comprising:
a second air curtain positioned within said building, comprising:
a second air intake duct;
a second blower in fluid communication with said air intake duct, said second blower operable to provide a second airflow into said second air intake duct and through said second blower;
a second distribution duct in fluid communication with said second blower, said second distribution duct receiving said second airflow; and
a second rotatable diffuser rotatably connected to said building, said second rotatable diffuser having a plurality of air outlets, said second rotatable diffuser in fluid communication with said second distribution duct, whereby said second airflow exits the second air curtain through said air outlets, said second rotatable diffuser rotatable between a first position in which said airflow is directed through said air outlets and out of a first of said pair of doors, and a second position in which said airflow is directed through said air outlets and out of a second of said pair of doors.

8. The combination of claim 7, wherein said rotatable diffuser is positioned adjacent said first of said pair of doors and spans a width of said first of said pair of doors, and wherein said second rotatable diffuser is positioned adjacent said second of said pair of doors and spans a width of said second of said pair of doors.

9. The combination of claim 5, wherein said distribution duct comprises a variable cross section duct, said variable cross section duct having a length, said variable cross section duct having a variable cross section along said length, whereby said airflow creates a substantially constant air pressure in said variable cross section duct.

10. The combination of claim 5, wherein said distribution duct includes air pressure means for creating a substantially constant air pressure in said distribution duct.

11. The combination of claim 5, wherein said variable cross section duct includes a plurality of vanes defining said plurality of air outlets.

12. The combination of claim 11, wherein each said vane has a height extending into said rotatable diffuser, and wherein a ratio of said height to a distance of separation between adjacent vanes equals 1.5.

13. The combination of claim 7, wherein said distribution duct comprises a variable cross-section duct, said variable cross-section duct having a length, said variable cross-section duct having a variable cross-section along said length, whereby said airflow creates a substantially constant air pressure in said variable cross-section duct, and wherein said second distribution duct comprises a second variable cross-section duct, said second variable cross-section duct having a length, said second variable cross-section duct having a variable cross-section along said length, whereby said airflow creates a substantially constant air pressure in said variable cross-section duct.

14. The combination of claim 7, wherein said distribution duct includes air pressure means for creating a substantially constant air pressure in said distribution duct, and wherein said second distribution duct includes air pressure means for creating a substantially constant air pressure in said second distribution duct.

15. The combination of claim 5, further comprising a motor operably connected to said rotating diffuser whereby energization of said motor causes rotation of said rotatable diffuser.

16. The combination of claim 15, further comprising:
wind detection means for detecting a direction of ambient wind; and
controller means for controlling energization of said motor responsive to the direction of ambient wind, said controller means communicatively connected to said wind detection means and said motor.

17. An air curtain, comprising:
an air intake duct;
a blower in fluid communication with said air intake duct, said blower operable to provide an airflow into said air intake duct and through said blower;
a variable cross section distribution duct in fluid communication with said blower, said variable cross section distribution duct receiving said airflow, said variable cross section duct having a length, said variable cross section duct having a variable cross section along said length, whereby said airflow creates a substantially constant air pressure in said variable cross section duct; and
a diffuser having a plurality of air outlets, said diffuser in fluid communication with said distribution duct, whereby said airflow exits the air curtain through said air outlets.

18. The air curtain of claim 17, wherein said diffuser comprises a rotatable diffuser rotatable relative to said variable cross section distribution duct.

19. An air curtain, comprising:
an air intake duct;
a blower in fluid communication with said air intake duct, said blower operable to provide an airflow into said air intake duct and through said blower;
a distribution duct in fluid communication with said blower, said distribution duct receiving said airflow, said distribution duct including air pressure means for creating a substantially constant air pressure in said distribution duct; and
a diffuser having a plurality of air outlets, said diffuser in fluid communication with said distribution duct, whereby said airflow exits the air curtain through said air outlets.
